(19) United States
(12) Patent Application Publication
(10) Pub. No.: US 2025/0109323 A1
(43) Pub. Date: Apr. 3, 2025

(54) CONDUCTIVE ADHESIVE FOR BIODEGRADABLE ELECTROCHEMICAL DEVICES AND METHODS THEREOF

(71) Applicant: XEROX CORPORATION, NORWALK, CT (US)

(72) Inventors: Gregory McGuire, Oakville (CA); Aleksa Dovijarski, Etobicoke (CA); Naveen Chopra, Oakville (CA); Yujie Zhu, Mississauga (CA)

(73) Assignee: XEROX CORPORATION, NORWALK, CT (US)

(21) Appl. No.: 18/479,968

(22) Filed: Oct. 3, 2023

(51) Int. Cl. C09J 9/02; C09J 5/00; C09J 11/04; C09J 187/00; H01M 50/293

(52) U.S. Cl. CPC C09J 9/02; C09J 5/00; C09J 11/04; C09J 187/005; H01M 50/293; C09J 2453/00

(57) ABSTRACT

An electrochemical device is described, including a first electrochemical cell, a second electrochemical cell, connected in series to the first electrochemical cell, and a biodegradable conductive adhesive may include a conductive additive and a copolymer including at least two polycaprolactone chains attached to a polymeric center block, where the polymeric center block may include polyvinyl alcohol, disposed between the first electrochemical cell and the second electrochemical cell. A biodegradable conductive adhesive includes a hydrogel which may include a copolymer having at least two polycaprolactone chains attached to a polymeric center block, where the polymeric center block may include polyvinyl alcohol. Implementations of the biodegradable conductive adhesive may include a conductive additive or a salt. The biodegradable adhesive can include a dried hydrogel, where the hydrogel is biodegradable.

### TECHNICAL FIELD

The present teachings relate generally to biodegradable electrochemical devices, electrolytes thereof, and fabrication methods for the same.

### BACKGROUND

The number of batteries being produced in the world is continuously increasing as a consequence of the growing need for portable and remote power sources. Particularly, a number of new technologies require batteries to power embedded electronics. For example, embedded electronics, such as portable and wearable electronics, Internet of Things (IoT) devices, patient healthcare monitoring, structural monitoring, environmental monitoring, smart packaging, or the like, rely on batteries for power. While conventional batteries may be partially recycled, there are currently no commercially available batteries that are environmentally friendly or biodegradable. As such, an increase in the manufacture and use of conventional batteries results in a corresponding increase in toxic and harmful waste in the environment if not properly disposed of or recycled. In view of the foregoing, there is a need to develop improved biodegradable batteries, especially for applications that utilize disposable batteries for a limited time before being discarded.

Many of the electronic devices and circuits including new battery designs require higher voltages than can be produced by a single cell. To achieve the required voltages, cells can be connected in series within a single pouch. The electrical connection is made from the cathode of a first cell to the anode of a second cell, and so on. Due to the stacked design of these cells, this connection cannot be a continuous current collector and is advantaged with the use of a conductive adhesive attachment. This adhesive connection would be further advantageous if also made using a biodegradable material in non-toxic solvents so as to not introduce persistent organic pollutants to the environment. Furthermore, the conditions for curing should be low temperature heating or ambient solvent evaporation so as to not damage the sensitive biodegradable structures of the battery, such as the substrate and gel electrolyte in particular. Unfortunately, there are no known commercial conductive adhesive materials available with biodegradable polymeric materials.

Thus, there is a need for a low temperature curable conductive adhesive with a biodegradable polymeric base material and non-toxic green solvent, with adequate adhesion to the carbon current collector.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An electrochemical device is disclosed. The electrochemical device also includes a first electrochemical cell, a second electrochemical cell, connected in series to the first electrochemical cell, and a biodegradable conductive adhesive may include a conductive additive and a copolymer including at least two polycaprolactone chains attached to a polymeric center block, where the polymeric center block may include polyvinyl alcohol, disposed between the first electrochemical cell and the second electrochemical cell. Implementations of the electrochemical device can include where the first electrochemical cell further may include a first anode, a first cathode, and a first biodegradable electrolyte composition disposed between the first anode and the first cathode, and the second electrochemical cell further may include a second anode, a second cathode, and a second biodegradable electrolyte composition disposed between the second anode and the second cathode. The biodegradable conductive adhesive forms a connection between the first cathode of the first electrochemical cell and the second anode of the second electrochemical cell. The first electrochemical cell may include a stacked geometry. The second electrochemical cell may include a stacked geometry. The biodegradable conductive adhesive further may include a hydrogel of the copolymer and a salt dispersed in the hydrogel of the copolymer. The conductive additive may include silver. The conductive additive may include a flake-shaped particle. The conductive additive may include carbon. The conductive additive is present in the biodegradable conductive adhesive in an amount from about 25 wt % to about 95 wt % based on a total weight of the biodegradable conductive adhesive. The electrochemical device may include a third electrochemical cell, connected in series to the second electrochemical cell.

A method of assembling a biodegradable electrochemical device is disclosed. The method includes adhering a first component of a biodegradable electrochemical cell to a second component of the biodegradable electrochemical cell using a biodegradable conductive adhesive, and drying the biodegradable adhesive, and where the biodegradable conductive adhesive may include a copolymer having at least two polycaprolactone chains attached to a polymeric center block, where the polymeric center block may include polyvinyl alcohol. Implementations of the method may include where the biodegradable conductive adhesive further includes a conductive additive. The biodegradable conductive adhesive may include before the drying a biodegradable hydrogel including the copolymer and water. The conductive additive further may include silver.

A biodegradable conductive adhesive is disclosed. The biodegradable conductive adhesive includes a hydrogel which may include a copolymer having at least two polycaprolactone chains attached to a polymeric center block, where the polymeric center block may include polyvinyl alcohol. The adhesive also includes water. The adhesive also includes where the hydrogel is biodegradable. Implementations of the biodegradable conductive adhesive may include a conductive additive. The conductive additive may include silver. The biodegradable conductive adhesive may include a salt.

A biodegradable adhesive is disclosed, including a dried hydrogel which can include a copolymer including at least two polycaprolactone chains attached to a polymeric center block, where the polymeric center block may include polyvinyl alcohol. The adhesive also includes where the hydrogel is biodegradable.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 illustrates an exploded view of an exemplary electrochemical device, in accordance with the present disclosure.

FIGS. 2A and 2B illustrate a top-view and a cross-sectional view, respectively, schematics of two biodegradable batteries connected in series using a conductive adhesive, in accordance with the present disclosure.

FIG. 3 is a schematic of an evaluation configuration for an electrochemical device connected using a conductive adhesive, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The following description of various typical aspect(s) is merely exemplary in nature and is in no way intended to limit the disclosure, its application, or uses.

As used throughout, ranges are used as shorthand for describing each and every value that is within the range. Any value within the range may be selected as the terminus of the range. In addition, all references cited herein are hereby incorporated by reference in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes examples containing A, B, or C, multiple examples of A, B, or C, or combinations of A/B, A/C, B/C, A/B/B/B/B/C, A/B/C, etc. In addition, throughout the specification, the meaning of “a,” “an,” and “the” include plural references. The meaning of “in” includes “in” and “on.”

Reference will now be made in detail to exemplary examples of the present teachings, examples of which are illustrated in the accompanying drawings. Wherever possible, the same reference numbers will be used throughout the drawings to refer to the same, similar, or like parts.

A biodegradable electrochemical device is disclosed herein. As used herein, the term “biodegradable” or “biodegradable material” may refer to a material, component, substance, device, or the like, capable of or configured to be decomposed by living organisms, particularly microorganisms in a landfill within a reasonable amount of time. The material, component, substance, device, or the like may be decomposed into water, naturally occurring gases like carbon dioxide and methane, biomass, or combinations thereof. As used herein, the expression “biodegradable electrochemical device” or “biodegradable device” may refer to an electrochemical device or a device, respectively, where at least one or more components thereof is biodegradable. In some instances, a majority or substantial number of the components of the biodegradable electrochemical device or the biodegradable device are biodegradable. In other instances, all of the polymer components of the biodegradable electrochemical device or the biodegradable device are biodegradable. For example, the polymers and/or other organic-based components of the electrochemical device are biodegradable while the inorganic materials of the electrochemical device disclosed herein, including the metals and/or metal oxides, may not be biodegradable. It should be appreciated that if all polymer and/or organic-based components of an electrochemical device are biodegradable, it is generally accepted that the complete electrochemical device is considered biodegradable. As used herein, the term “compostable” may refer to items that are able to be made into compost or otherwise disposed of in a sustainable or environmentally friendly manner. Compostable materials may be considered to be a subset category of biodegradable materials wherein additional specific environmental temperatures or conditions may be needed to break down a compostable material. While the term compostable is not synonymous with biodegradable, they may be used interchangeably in some instances, wherein the conditions necessary to break down or decompose a biodegradable material are understood to be similar to the conditions necessary to break down a compostable material. As used herein, the term or expression “electrochemical device” may refer to a device that converts electricity into chemical reactions and/or vice-versa. Illustrative electrochemical devices may be or include, but are not limited to, batteries, die-sensitized solar cells, electrochemical sensors, electrochromic glasses, fuel cells, electrolysers, or the like.

As used herein, the term or expression “environmentally friendly electrochemical device” or “environmentally friendly device” may refer to an electrochemical device or device, respectively, that exhibits minimal, reduced, or no toxicity to the ecosystems or the environment in general. In at least one embodiment, the electrochemical devices and/or components thereof disclosed herein are environmentally friendly.

As used herein, the term or expression “film” or “barrier layer” may refer to a thin, partially or substantially plastic and/or polymeric material that may be used in various electrochemical device components or parts, including, but not limited to substrates, connections, enclosures, barriers, or combinations thereof. Films as described herein may be rigid or flexible, depending upon the inherent physical properties or dimensions of their respective compositions. In at least one embodiment, these films or barrier layers may be environmentally friendly or biodegradable

As used herein, the term or expression “enclosure,” “barrier,” or “water vapor barrier” may refer to materials utilized in partially sealed, fully sealed or otherwise used to prevent moisture, water or other evaporable materials from entering or exiting via the barrier of an electrochemical device. In at least one embodiment, these enclosures may be environmentally friendly or biodegradable.

In at least one embodiment, the electrochemical device disclosed herein may include an anode, a cathode (i.e., a current collector and/or an active layer), and one or more biodegradable electrolyte compositions (e.g., a biodegradable solid aqueous electrolyte composition). In another embodiment, the biodegradable electrochemical device may further include one or more substrates, one or more seals, one or more packages, one or more pouches, one or more enclosures, or combinations thereof.

The electrochemical devices disclosed herein may be flexible. As used herein, the term “flexible” may refer to a material, device, or components thereof that is capable of being bent around a predetermined radius of curvature without breaking and/or cracking. The biodegradable electrochemical devices and/or the components thereof disclosed herein may be bent around a radius of curvature of about 30 cm or less, about 20 cm or less, about 10 cm or less, about 5 cm or less without breaking or cracking.

The number of batteries being produced in the world continuously increases as a consequence of the growing need for portable and remote power sources, and the number of new technologies requiring batteries to power embedded electronics. For example, embedded electronics, such as portable and wearable electronics, Internet of Things (IoT) devices, patient healthcare monitoring, structural monitoring, environmental monitoring, smart packaging, or the like, rely on batteries for power. While conventional batteries may be partially recycled, there are currently no commercially available batteries that are environmentally friendly or biodegradable. As such, an increase in the manufacture and use of conventional batteries results in a corresponding increase in toxic and harmful waste in the environment if not properly disposed of or recycled. In view of the foregoing, recent developments in biodegradable, flexible, all-printed batteries comprising a biodegradable substrate and a radiatively curable biodegradable polymer gel electrolyte have occurred. It would be further advantageous to provide conductive adhesive materials available with biodegradable polymeric materials for connections within and between biodegradable electrochemical devices, such as, for example, batteries. The present teachings provide an electrochemical device including a first electrochemical cell, a second electrochemical cell, connected in series to the first electrochemical cell, and a biodegradable conductive adhesive disposed between the first electrochemical cell and the second electrochemical cell.

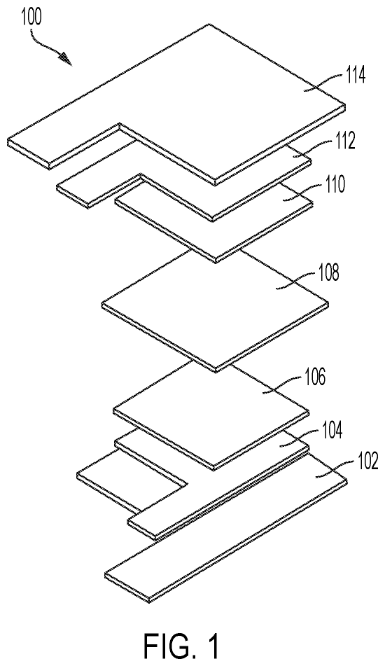

FIG. 1 illustrates an exploded view of an exemplary electrochemical device in a stacked configuration, in accordance with the present disclosure. As illustrated in FIG. 1, the electrochemical device 100 or cell may include a first substrate 102, a first carbon current collector 104 disposed adjacent to or on top of the first substrate 102, an anode active layer 106 disposed adjacent to or on top of the first carbon current collector 104, an electrolyte layer 108 disposed adjacent to or on top of the anode 106, a cathode active layer 110 disposed adjacent to or on top of the electrolyte composition 108, a second carbon current collector 112 disposed adjacent to or on top of the cathode active layer 110, and a second substrate 114 disposed adjacent to or on top of the second carbon current collector 112. It should be appreciated that the first carbon current collector 104 and the anode active layer 106 may be collectively referred to herein as an anode of the electrochemical device 100. It should further be appreciated that the second carbon current collector 112 and the cathode active layer 110 may be collectively referred to herein as a cathode of the electrochemical device 100. As illustrated in FIG. 1, the anode and the cathode of the electrochemical device 100 may be arranged in a stacked configuration or stacked geometry such that the anode and the cathode are disposed on top of or below one another.

In certain examples, the electrochemical device 100 may include one or more seals, not shown here, capable of or configured to hermetically seal the carbon current collectors 104, 112, the anode active layer 106, the cathode active layer 110, and the electrolyte composition 108 between the first and second substrates 102, 114 of the electrochemical device 100. In another example, the electrochemical device 100 may be free or substantially free of seals, as shown in FIG. 1. For example, the substrates 102, 114 may be melted or bonded with one another to seal the electrochemical device 100. In still other examples, each of the carbon current collectors 104, 112, may include a respective tab that may extend outside the body of the electrochemical device 100 to thereby provide connectivity. In some examples, the electrochemical device 100 may be arranged in a side-by-side or coplanar configuration. Further, the anode and the cathode of the electrochemical device 100 may be coplanar such that the anode and the cathode are arranged along the same X-Y plane. In examples, the electrochemical device may be comprised of more than one of the structures as shown in FIG. 1, arranged in an array of cells which can be interconnected by one or more electrical connections, which will be described in further detail herein.

In at least one example, any one or more of the substrates of the electrochemical device 100 may be or include, but is not limited to, a biodegradable substrate. Illustrative biodegradable substrates may be or include, but are not limited to, one or more of polylactic acid (PLA), polylactic-co-glycolic acid (PLGA), silk-fibroin, chitosan, polycaprolactone (PCL), polyhydroxybutyrate (PHB), rice paper, cellulose, or combinations or composites thereof.

The biodegradable substrates of the respective biodegradable electrochemical devices 100 may be stable at temperatures of from about 50° C. to about 150° C. As used herein, the term “stable” or “stability” may refer to the ability of the substrate to resist dimensional changes and maintain structural integrity when exposed to temperature of from about 50° C. to about 150° C. For example, the biodegradable substrates may be capable of or configured to maintain structural integrity with dimensional changes of less than about 20%, less than about 15%, or less than about 10% after exposure to temperatures of from about 50° C. to about 150° C. In one example, each of the biodegradable substrates may be stable (e.g., dimensional changes less than 20%) at a temperature of from about 50° C., about 60° C., about 70° C., about 80° C., about 90° C., about 100° C., or about 110° C. to about 120° C., about 130° C., about 140° C., or about 150° C. In another example, each of the biodegradable substrates may be stable at a temperature of at least 100° C., at least 105° C., at least 110° C., at least 115° C., at least 120° C., at least 125° C., at least 130° C., at least 135° C., at least 140° C., or at least 145° C. In at least one embodiment, the biodegradable substrates may be stable at temperatures of from about 50° C. to about 150° C. for a period of from about 5 min to about 60 min or greater. For example, the biodegradable substates may be stable at the aforementioned temperatures for a period of time from about 5 min, about 10 min, about 20 min, or about 30 min to about 40 min, about 45 min, about 50 min, about 60 min, or greater.

In at least one embodiment, the biodegradable substrate is weldable, bondable, and/or permanently thermo-sealable without the use of an additional adhesive. For example, the biodegradable substrates of each of the substrates 102, 114 may be weldable and/or bondable with one another without the use of respective seals. Illustrative biodegradable substrates that may be weldable and/or bondable with one another may be or include, but are not limited to, thermoplastics, such as polylactic acid (PLA), polylactides modified with a nucleating agent to enhance crystallinity, such as polylactide polybutylene succinate (PBS), polybutylene adipate terephthalate (PBAT), blends of PLA and polyhydroxybutyrate (PHB), PHB-based blends, or the like, or combinations thereof. As used herein, the term or expression “bondable,” “weldable,” and/or “permanently thermo-sealable” may refer to an ability of a material (e.g., substrate) to heat seal two surfaces with one another or permanently join two surfaces with one another via heating or melting.

The anode active layer 106 of exemplary biodegradable electrochemical devices 100 may be or include, but are not limited to, one or more of zinc (Zn), lithium (Li), carbon (C), cadmium (Cd), nickel (Ni), magnesium (Mg), magnesium alloys, zinc alloys, or the like, or combinations and/or alloys thereof. Illustrative anode active layers or materials thereof may be or include, but are not limited, or the like, or combinations thereof. In at least one embodiment, the anode active layer may include zinc oxide (ZnO) in a sufficient amount to regulate or control H₂ gassing.

In at least one example, the anode active layer 106 of exemplary biodegradable electrochemical devices 100 may be prepared or fabricated from an anode paste. For example, the anode active layer may be prepared from a zinc anode paste. The anode paste may be prepared in an attritor mill. In at least one embodiment, stainless steel shot may be disposed in the attritor mill to facilitate the preparation of the anode paste. The anode paste may include one or more metal or metal alloys, one or more organic solvents, one or more styrene-butadiene rubber binders, or combinations thereof. In an exemplary embodiment, the anode paste may include one or more of ethylene glycol, a styrene-butadiene rubber binder, zinc oxide (ZnO), bismuth (III) oxide (Bi₂O₃), Zn dust, or combinations thereof. Illustrative organic solvents are known in the art and may be or include, but are not limited to, ethylene glycol, acetone, NMP, or the like, or combinations thereof. In at least one embodiment, any one or more biodegradable binders may be utilized in lieu of or in combination with a styrene-butadiene rubber binder and may include, but are not limited to, Alginate, Chitosan, Guar gum, Gluten, and the like.

The cathode active layer 110 of exemplary biodegradable electrochemical devices 100 may be or include, but are not limited to, one or more of iron (Fe), iron (VI) oxide, mercury oxide (HgO), manganese (IV) oxide (MnO₂), carbon (C), carbon-containing cathodes, gold (Au), molybdenum (Mo), tungsten (W), molybdenum trioxide (MoO₃), silver oxide (Ag₂O), copper (Cu), vanadium oxide (V₂O₅), nickel oxide (NiO), copper iodide (Cu₂I₂), copper chloride (CuCl), or the like, or combinations and/or alloys thereof. In an exemplary example, the cathode active layer 110 may include manganese (IV) oxide. The carbon and/or carbon-containing cathode active layers may be utilized in aqueous metal-air batteries, such as zinc air batteries.

In at least one example, the cathode active layer 110 may include one or more additives capable of or configured to at least partially enhance the electronic conductivity of the cathode active layer 110. Illustrative additives may be or include, but are not limited to, carbon particles, such as graphite, carbon nanotubes, carbon black, or the like, or the like, or combinations thereof.

In at least one example, the cathode active layer 110 of an exemplary biodegradable electrochemical device 100 may be prepared or fabricated from a cathode paste. For example, the cathode active layer 110 may be prepared from a manganese (IV) oxide cathode paste. The cathode paste may be prepared in an attritor mill. In at least one example, stainless steel shot may be disposed in the attritor mill to facilitate the preparation of the cathode paste. The cathode paste may include one or more metal or metal alloys, one or more organic solvents (e.g., ethylene glycol), one or more styrene-butadiene rubber binders, or combinations thereof. In an exemplary example, the cathode paste may include one or more of ethylene glycol, a styrene-butadiene rubber binder, manganese (IV) oxide (MnO₂), graphite, or combinations thereof. Illustrative organic solvents are known in the art and may be or include, but are not limited to, ethylene glycol, acetone, NMP, or the like, or combinations thereof. In at least one example, the one or more organic solvents may be replaced or used in combination with an aqueous solvent, such as water. For example, water may be utilized in combination with manganese (IV) oxide or other additives.

Once these electrode layers are formed, there can still exist interstitial spaces or inherent porosity within the bulk of the electrode layer that can be displaced by at least a portion of the electrolyte layer when fabricated according to the present teachings. This impregnation or interpenetration of the electrolyte material into the electrode material can provide improved adhesion and improved contact between components of an electrochemical device. This concept can apply to various binders, cathode paste, anode paste, active layer material, or a combination thereof, provided these materials are in contact with the electrolyte composition. Once the electrolyte pre-cure contacts the roughened surfaces of the electrodes, and is cured in situ, the intimate interaction of crosslinked electrolyte with the electrode, would result in an interlayer boundary where any efforts to peel apart the device would result in destruction and ‘tearing apart’ of the electrode due to the stronger cohesive bond. This is in contrast with a separately cured electrolyte which would likely result in cohesive failure, and the layer would cleanly peel away from the electrode with minimal impact.

In at least one embodiment, each of the anodes and the cathodes, or the active layers 106, 110 thereof may independently include a biodegradable binder. The function of the biodegradable binder is to anchor the particles of each of the respective layers together and provide adhesion to the substrate underneath, the respective layers being the anode carbon current collector 104, the cathode carbon current collector 112 the anode active layer 106, the cathode active layer 110, or combinations thereof. Illustrative biodegradable binders may be or include, but are not limited to, one or more of chitosan, polylactic-co-glycolic acid (PLGA), gelatin, xanthan gum, cellulose acetate butyrate (CAB), polyhydroxybutyrate (PHB), alginate, derivatives of alginate, such as M-alginate, or a combination thereof. In at least one embodiment, any one or more of the biodegradable polymers disclosed herein with regard to the electrolyte composition may also be utilized as the biodegradable binder of the anode, the cathode, components thereof, or any combination thereof. As further described herein, the one or more biodegradable polymers may be cross-linked. As such, the biodegradable binders utilized for the anode, the cathode, and/or the components thereof, may include the cross-linked biodegradable binders disclosed herein with regard to the electrolyte composition.

The electrolyte layer 108 of exemplary biodegradable electrochemical devices 100 may be or include an electrolyte composition that is also biodegradable. The biodegradable electrolyte composition may utilize biodegradable polymeric materials. The electrolyte composition may be a solid, aqueous electrolyte composition. The solid, aqueous electrolyte composition may be or include a hydrogel of a copolymer and a salt dispersed in and/or throughout the hydrogel. The copolymer may include at least two polycaprolactone (PCL) chains attached with a polymeric center block (CB). For example, the copolymer may be a block copolymer or a graft copolymer including at least two PCL chains coupled with the polymeric center block, such as PCL-CB-PCL. In another example, the copolymer may be a block copolymer or a graft copolymer including at least one or more of polylactic acid (PLA), polyglycolic acid (PGA), polyethylene imine (PEI) or combinations thereof, coupled with the polymeric center block.

The copolymer or the solids may be present in the hydrogel in an amount of from about 5 weight % or greater to 90 weight % or less, based on a total weight of the hydrogel (e.g., total weight of solvent, polymer, and salt). For example, the copolymer may be present in an amount of from about 5 weight % or greater, 10 weight % or greater, 15 weight % or greater, 20 weight % or greater, 25 weight % or greater, 30 weight % or greater, 35 weight % or greater, based on a total weight of the hydrogel. In another example, the copolymer may be present in an amount of from 90 weight % or less, 80 weight % or less, 70 weight % or less, or 60 weight % or less, based on a total weight of the hydrogel. In a preferred embodiment, the copolymer or the solids may be present in the hydrogel in an amount of from about 5 weight % to about 60 weight %, about 5 weight % to about 50 weight %, about 20 weight % to about 40 weight %, or about 30 weight %, based on a total weight of the hydrogel. In yet another preferred embodiment, the copolymer or the solids may be present in the hydrogel in an amount of from greater than 30 weight % to 60 weight %, based on a total weight of the hydrogel.

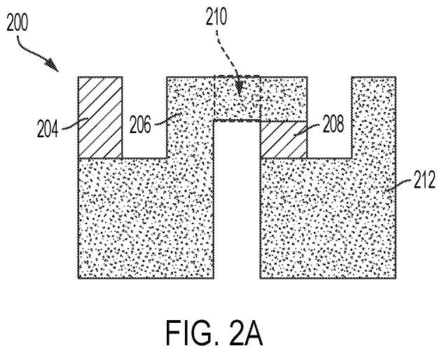

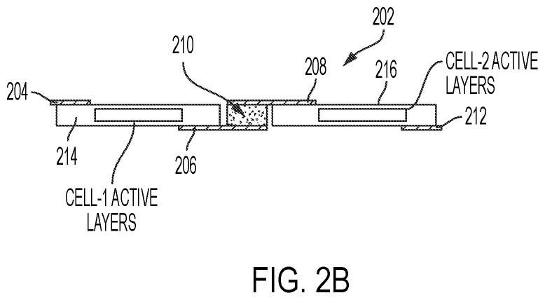

FIGS. 2A and 2B illustrate a top-view schematic and a side view schematic, respectively, of two biodegradable batteries connected in series using a conductive adhesive, in accordance with the present disclosure. An electrochemical device assembly top view 200 is shown in FIG. 2A, while an electrochemical device assembly side view 202 is shown in FIG. 2B. The electrochemical device assembly has a first anode 204 of a first cell, a first cathode 206 of a first cell, a second anode 208 of a second cell, and a second cathode 212 of a second cell where a connection comprising a conductive adhesive 210 connects the first cathode 206 to the second anode 208. As shown in FIG. 2B, in the side view 202, it can be seen there is a first cell active layer 214 between the first anode 204 and the first cathode 206, and a second cell active layer 216 between the second anode 208 and the second cathode 212. While two cells are shown in FIGS. 2A and 2B, in other examples, more than two cells can be interconnected between an electrode of a cell and an electrode of a neighboring or subsequent cell. In still other examples, up to 10 cells can be connected by a biodegradable conductive adhesive, as shown in FIGS. 2A and 2B, or in other examples, a practical upper limit of cells could be three cells, capable of achieving a total of 4.5 V. Many of the electronic devices and circuits that can find use for the battery designs as described herein require higher voltages than can be produced by a single cell. To achieve the required voltages, cells can be connected in series within a pouch or other such structure for containing an array of biodegradable electrochemical cells. FIG. 2A The electrical connection is made from the first cathode 206 of a first cell to the second anode 208 of a second cell, and so on. Due to the stacked design of the illustrated cells, this connection cannot be a continuous current collector and must be a conductive adhesive attachment 210. This conductive adhesive 210 connection is made using a biodegradable material in non-toxic solvents so as to not introduce persistent organic pollutants to the environment. Furthermore, the conditions for curing are preferably low temperature heating or ambient solvent evaporation so as to not damage any other sensitive biodegradable structures of the battery, such as, for example, the substrate and gel electrolyte. At present, there are no known commercial conductive adhesive materials available with biodegradable polymeric materials. In examples, pressure can be applied to insure complete and full contact between electrodes (anode or cathode) or electrode tabs of neighboring biodegradable electrochemical cells within a device. Such a method of assembling a biodegradable electrochemical device can include adhering a first component of a biodegradable electrochemical cell to a second component of the biodegradable electrochemical cell using a biodegradable conductive adhesive, and drying the biodegradable adhesive. In examples, the biodegradable conductive adhesive includes a copolymer having at least two polycaprolactone chains attached to a polymeric center block, wherein the polymeric center block comprises polyvinyl alcohol. In other examples, the biodegradable conductive adhesive comprises before the drying a biodegradable hydrogel including the copolymer and water. The dried hydrogel material can be considered the base or matrix for the biodegradable conductive adhesive.

In previous examples, it was determined there was a need for a low temperature curable conductive adhesive with a biodegradable polymeric base material and non-toxic green solvent, with adequate adhesion to the carbon current collector, as shown in FIGS. 2A and 2B. As there are no known commercially available biodegradable conductive adhesives to solve this problem, the following alternative examples were produced. First, a conductive copper tape was used to connect the anode of a first battery to the cathode of a second battery. The result was a poor, unreliable connection as the tape would slowly delaminate or the copper would corrode within the battery package due to contact with the electrolyte salt. Next, a hot glue, comprised of thermoplastic ethyl vinyl acetate (EVA) was an identified adhesive that would strongly adhere to the carbon current collector and polyethylene terephthalate (PET), and only require ambient curing. Despite it not being conductive and not biodegradable, it works by forming a pressure contact between the anode and cathode due to the high strength adhesion. This connection lasted longer than copper tape before introducing reliability issues and failures, but was also not a biodegradable adhesive. As such, the conductive adhesives of the present teachings were developed.

### Printed Electronics Conductive Adhesive

Printed Electronics is an emerging industry that aims to print low-cost electronic components to add function to otherwise inanimate objects. Unlike conventional electronics, the field of printed electronics is not restricted to rigid substrates; rather, printed electronics targets flexible and/or non-planar substrates, typically plastics having a low glass transition temperature (Tg). However, printed electronics is still in its early stages and resulting devices do not achieve the computing power of conventional silicon technology. Hybrid electronics combines the computing power of conventional silicon microchip technology with the low cost of printed electronics. Conventional electronics use robust interconnects such as solder balls, wire-bonding, and ACP (anisotropic conductive pastes) to attach microchips, capacitors, diodes, and other circuit elements. An ideal conductive adhesive would have a minimum conductivity of 1000 S/cm, high adhesive strength, low curing temperature, to accommodate the low Tg substrates, and biodegradability to enable integration onto biodegradable substrates and packaging.

As mentioned previously, most commercially available conductive adhesives that have adequate conductivity require high temperature curing to achieve conductivity and adequate adhesion to common printed electronics plastic substrates such as polyethylene terephthalate (PET), polyethylene naphthalate (PEN), and polycarbonate (PC), and are not biodegradable.

During the development of a proprietary GPE-3 polymer electrolyte, as shown in Scheme 1 below, it was observed that the electrolyte pre-cured solution unexpectedly demonstrated high cohesiveness and was extremely difficult to handle due to very high tackiness to all surfaces when cured or dried into a dried hydrogel. It can even be described as “glue-like.” This phenomenon was enhanced significantly when the pre-cured solution was allowed to air dry. The removal of solvent by evaporation caused the gelling solution to solidify onto substrates with extremely strong adhesion. Thus, it was discovered that it could be used as an adhesive, either UV-cured or heat cured. Therefore, in examples, while the electrolyte can be cured with ultraviolet (UV) radiation or heat, as no catalyst need be added, the curing can be considered synonymous with drying. Thus, a cured or dried electrolyte material or dry cured adhesive can be used interchangeably herein. Since this material was biodegradable and there is a present need for a biodegradable conductive adhesive, this material has been adapted with the addition of conductive particles for use in such applications, as a conductive adhesive.

The GPE polymer used for conductive adhesive as described herein is a graft polymer with the generic structure shown below:

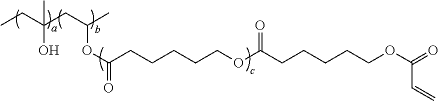

An exemplary example of a GPE polymer is a PVA main polymer chain, with PCL side pendant groups or side chains as shown in the structure below:

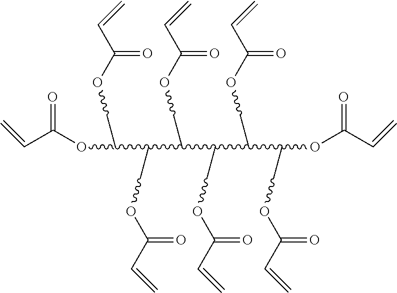

An exemplary formulation of gel polymer electrolyte may include the following composition. A gel polymer electrolyte composition was prepared in water, as shown in Table 1.

TABLE 1
Gel Polymer Electrolyte composition

| Component | Mass (g) | % by weight |
|---|---|---|
| GPE polymer | 18 | 31.0 |
| Electrolyte (salt in water) | 40 | 68.9 |
| LAP (photoinitiator) | 0.04 | 0.06 |
| TOTAL | 58.04 | 100.0 |

The electrolyte layer of each of the respective biodegradable electrochemical devices may be or include an electrolyte composition. The electrolyte composition may utilize biodegradable polymeric materials. The electrolyte composition may be a solid, aqueous electrolyte composition. The solid, aqueous electrolyte composition may be or include a hydrogel of or including a copolymer and a salt dispersed in and/or throughout the hydrogel. The copolymer may include at least two polycaprolactone (PCL) chains attached or coupled with a polymeric center block (CB). For example, the copolymer may be a block copolymer or a graft copolymer including at least two PCL chains coupled with the polymeric center block, such as PCL-CB-PCL. In another example, the copolymer may be a block copolymer or a graft copolymer including at least one or more of polylactic acid (PLA), polyglycolic acid (PGA), polyethylene imine (PEI) or combinations thereof, coupled with the polymeric center block.

The copolymer or the solids may be present in the hydrogel in an amount of from about 5 weight % or greater to 90 weight % or less, based on a total weight of the hydrogel (e.g., total weight of solvent, polymer, and salt). For example, the copolymer may be present in an amount of from about 5 weight % or greater, 10 weight % or greater, 15 weight % or greater, 20 weight % or greater, 25 weight % or greater, 30 weight % or greater, 35 weight % or greater, based on a total weight of the hydrogel. In another example, the copolymer may be present in an amount of from 90 weight % or less, 80 weight % or less, 70 weight % or less, or 60 weight % or less, based on a total weight of the hydrogel. In a preferred embodiment, the copolymer or the solids may be present in the hydrogel in an amount of from about 5 weight % to about 60 weight %, about 5 weight % to about 50 weight %, about 20 weight % to about 40 weight %, or about 30 weight %, based on a total weight of the hydrogel. In yet another preferred embodiment, the copolymer or the solids may be present in the hydrogel in an amount of from greater than 30 weight % to 60 weight %, based on a total weight of the hydrogel.

The copolymer may be present in the hydrogel in an amount sufficient to provide a continuous film or layer that is free or substantially free of bubbles. The copolymer may also be present in the hydrogel in an amount sufficient to provide a viscosity of from about 1,000 cP to about 100,000 cP. For example, the copolymer may be present in the hydrogel in an amount sufficient to provide a viscosity of from about 1,000 cP, about 5,000 cP, about 10,000 cP, or about 20,000 cP to about 30,000 cP, about 40,000 cP, about 50,000 cP, about 75,000 cP, about 90,000 cP, or about 100,000 cP.

The polymeric center block of the copolymer may be a biodegradable polymer, thereby improving or increasing biodegradability of the solid, aqueous electrolyte composition. The biodegradable polymer of the polymeric center block is preferably naturally occurring. The polymeric center block may be or include, or be derived from, a polymer, such as a biodegradable polymer, including at least two free hydroxyl groups available for reaction with E-caprolactone. As further described herein, the polymer including the at least two free hydroxyl groups may be reacted with ¿-caprolactone to form the copolymer. Illustrative polymers including at least two free hydroxyl groups that may be utilized include, but are not limited to, one or more of polyvinyl alcohol (PVA), a hydroxyl-bearing polysaccharide, a biodegradable polyester, a hydroxy fatty acid (e.g., castor oil), or the like, or combinations thereof. Illustrative hydroxyl-bearing polysaccharides may be or include, but are not limited to, starch, cellulose, carboxymethyl cellulose, methyl cellulose, hydroxyethyl cellulose, chitin, guar gum, xanthan gum, agar-agar, pullulan, amylose, alginic acid, dextran, or the like, or combinations thereof. Illustrative biodegradable polyesters may be or include, but are not limited to, polylactide, polyglycolic acid, polylactide-co-glycolic acid, polyitaconic acid, polybutylene succinate, or the like, or combinations thereof. In a preferred embodiment, the polymer center block may be or include one or more of polyvinyl alcohol (PVA), a hydroxyl-bearing polysaccharide, a biodegradable polyester, or a hydroxy fatty acid.

In at least one embodiment, the polymeric center block of the copolymer may not be a biodegradable polymer. For example, the polymeric center block of the copolymer may be or include, but is not limited to, polyethylene glycol (PEG), hydroxy-terminated polyesters, hydroxyl-terminated polyolefins, such as hydroxy-terminated polybutadiene, or the like, or combinations thereof.

The copolymer, including at least two polycaprolactone (PCL) chains bonded to the polymeric center block, may be a graft copolymer or a block copolymer. Whether the copolymer is a graft copolymer or a block copolymer may be at least partially determined by the number and/or placement of the at least two free hydroxyl groups of the polymeric center block. For example, reacting ¿-caprolactone with polymeric center blocks having the hydroxyl groups on monomers along a length of the polymeric center block chain forms graft copolymers. In another example, reacting ¿-caprolactone with polymeric center blocks having each of the hydroxyl groups at respective ends of the polymeric center blocks forms block copolymers. Illustrative block copolymers may be or include triblock copolymers, tetrablock copolymers, star block copolymers, or combinations thereof.

In an exemplary implementation, the solid, aqueous electrolyte composition may be or include a hydrogel of a copolymer, where the copolymer includes a biodegradable polymeric center block (CB) of polyvinyl alcohol (PVA) having at least two polycaprolactone (PCL) chains. Particularly, the copolymer is a PVA-graft-PCL copolymer. As further described herein, preparing the PVA-graft-PCL copolymer may include reacting e-caprolactone with the PVA.

It should be appreciated that PVA is prepared through the polymerization of vinyl acetate to poly(vinyl acetate), and subsequent hydrolysis of the poly(vinyl acetate) to hydrolyze the acetate functional groups of the poly(vinyl acetate) to secondary hydroxyl groups to thereby prepare the PVA. In at least one implementation, the PVA utilized to prepare the PVA-graft-PCL copolymer has a degree of hydrolysis of about 80% or less. For example, the PVA may have a degree of hydrolysis of from about 30% to about 60% or less, about 65% or less, about 70% or less, about 75% or less, or about 80% or less. In another example, the PVA may have a degree of hydrolysis of from about 30%, about 40%, about 50%, or about 55% to about 60% or less, about 65% or less, about 70% or less, about 75% or less, or about 80% or less. As such, it should be appreciated that the PVA may have at least primary hydroxyl groups, secondary hydroxyl groups, and acetate functional groups. The degree of hydrolysis of the PVA may at least determine a solubility of the PVA. For example, a relatively lower degree of hydrolysis increases solubility due to the “open” or “unfolded” polymeric PVA chain, the greater amounts of the residual acetate groups, or combinations thereof. As further demonstrated below, the degree of hydrolysis of the PVA may at least partially determine one or more properties of the resulting solid, aqueous electrolyte composition. For example, the degree of hydrolysis of the PVA may at least partially determine a physical property of the solid, aqueous electrolyte composition or a component thereof, such as elasticity, brittleness, the level of grafting of the PCL to the PVA, or combinations thereof.

As discussed above, preparing the PVA-graft-PCL copolymer may include reacting ¿-caprolactone with the PVA. The E-caprolactone may react with the terminal or primary hydroxyl groups of the PVA. The E-caprolactone may also react with the secondary hydroxyl groups of the PVA polymeric chain to thereby provide the PVA-PCL graft copolymer. In at least one implementation, the mole ratio of the e-caprolactone (CL) to the PVA may be varied. The mole ratio of the CL: PVA may be from about 0.2:1 to about 1:1, about 0.2:1 to about 0.8:1, about 0.25:1 to about 0.75:1, about 0.3:1 to about 0.7:1, about 0.35:1 to about 0.65:1, or about 0.4:1 to about 0.6:1. The mole ratio of CL: PVA may be greater than or equal to 0.2:1 and less than or equal to 0.3:1, less than or equal to 0.4:1, less than or equal to 0.5:1, less than or equal to 0.6:1, less than or equal to 0.7:1, or less than or equal to 0.75:1. The mole ratio of the CL: PVA may be greater than or equal to 0.2:1, greater than or equal to 0.3:1, greater than or equal to 0.4:1, greater than or equal to 0.5:1, greater than or equal to 0.6:1, or greater than or equal to 0.7:1, and less than or equal to 0.75:1. As further demonstrated below, the mole ratio of the CL: PVA may at least partially determine one or more properties of the resulting solid, aqueous electrolyte composition. For example, the mole ratio of the CL: PVA may at least partially determine a physical property of the solid, aqueous electrolyte composition or a component thereof, such as elasticity, brittleness, the level of grafting of the PCL to the PVA, or combinations thereof. In at least one implementation, the mole ratio may be at least partially determined by a molecular weight of the PVA. For example, utilizing relatively higher molecular weight (i.e., >30 kDa) PVA may increase the mole ratio of the CL: PVA sufficient to provide the rubber-like hydrogel. In another example, utilizing relatively lower molecular weight (<30 kDa) PVA may decrease the mole ratio of the CL: PVA sufficient to provide the rubber-like hydrogel.

As discussed above, the degree of hydrolysis of the PVA and/or the mole ratio of the CL: PVA may at least partially determine a physical property of the solid, aqueous electrolyte composition or a component thereof. For example, the degree of hydrolysis of the PVA and/or the mole ratio of the CL: PVA may be varied to provide the hydrogel with a rubber-like consistency or to provide a rubber-like hydrogel. As used herein, the term or expression “rubber-like” may refer to a material having unique properties of deformation (i.e., elongation or yield under stress) and elastic recovery. As used herein, the term or expression “rubber-like hydrogel” may refer to a hydrogel or a crosslinked hydrophilic polymer having unique properties of deformation and elastic recovery.

The PVA-graft-PCL copolymer may include the CL in an amount of from about 5 wt % to about 20 wt %, based on the total weight of the PVA-graft-PCL copolymer. For example, the CL may be present in the PVA-graft-PCL copolymer in an amount of from about 5 wt %, about 8 wt %, or about 10 wt % to about 12 wt %, about 15 wt %, about 18 wt %, or about 20 wt %, based on the total weight of the PVA-graft-PCL copolymer.

The PVA-graft-PCL copolymer of the electrolyte compositions disclosed herein may include various functional groups. Particularly, the PVA-graft-PCL copolymer may include acetate functional groups (e.g., the unreacted acetate functional groups from the partially hydrolyzed PVA), hydroxyl functional groups, acrylate functional groups, or combinations thereof. In at least one implementation, about 20% to about 70% of the functional groups of the PVA-graft-PCL copolymer may be acetate functional groups. For example, the PVA-graft-PCL copolymer of the electrolyte composition may retain from about 20% to about 70% acetate functional groups. The acetate functional groups may be present in an amount of from about 20%, about 25%, about 30%, or about 35% to about 50%, about 55%, about 60%, about 65%, or about 70%, based on the total amount of functional groups.

As discussed above, the electrolyte composition may be a solid, aqueous electrolyte composition including the hydrogel of the copolymer and the salt dispersed in the hydrogel. The salt of the hydrogel may be or include any suitable ionic salt known in the art. Illustrative ionic salts may be or include, but are not limited to, one or more of organic-based salts, inorganic-based salts, room temperature ionic liquids, deep eutectic solvent-based salts, or the like, or combinations or mixtures thereof. In a preferred embodiment, the salts are or include salts useable in zinc/manganese (IV) oxide (Zn/MnO₂) electrochemistry. Illustrative salts may be or include, but are not limited to, zinc chloride (ZnCl₂), ammonium chloride (NH₄Cl), sodium chloride (NaCl), phosphate-buffered saline (PBS), sodium sulfate (Na₂SO₄), zinc sulfate (ZnSO₄), manganese sulfate (MnSO₄), magnesium chloride (MgCl₂), calcium chloride (CaCl₂)), ferric chloride (FeCl₃), lithium hexafluorophosphate (LiPF₆), potassium hydroxide (KOH), sodium hydroxide (NaOH), or the like, or combinations thereof. In a preferred embodiment, the salt of the electrolyte composition may be or include ammonium chloride (NH₄Cl), zinc chloride (ZnCl₂), or a combination or mixture thereof. In another embodiment, the salt may be or include alkali metal salts, such as sodium hydroxide (NaOH), ammonium hydroxide (NH₄OH), potassium hydroxide (KOH), or combinations or mixtures thereof.

The salt may be present in an amount capable of, configured to, or sufficient to provide ionic conductivity. For example, the salt may be present in the hydrogel in an amount or concentration of at least 0.1M, more preferably at least 0.5M, even more preferably at least 2M, even more preferably at least 4M. The salt may be present in the hydrogel at a concentration of 10M or less, more preferably 6M or less. In another example, the salt may be present in the hydrogel in an amount of from about 3M to about 10M, about 4M to about 10M, about 5M to about 9M, or about 6M to about 8M. In an exemplary implementation, the salts included ammonium chloride and zinc chloride, where ammonium chloride is present in an amount of from about 2.5M to about 3M, about 2.8M to about 2.9M, or about 2.89M, and where zinc chloride is present in an amount of from about 0.5M to 1.5M, about 0.8M to about 1.2M, or about 0.9M.

In at least one embodiment, the electrolyte composition may include one or more additives. The one or more additives may be or include, but are not limited to, biodegradable or environmentally friendly nanomaterials. The biodegradable nanomaterials may be capable of or configured to provide and/or improve structural strength of the electrolyte layer or the electrolyte composition thereof without sacrificing flexibility of the electrolyte layer or the electrolyte composition thereof. Illustrative biodegradable nanomaterials of the additives may be or include, but are not limited to, polysaccharide-based nanomaterials, inorganic nanomaterials, or the like, or combinations thereof. Illustrative polysaccharide-based nanomaterials may be or include, but are not limited to, one or more of cellulose nanocrystals, chitin nanocrystals, chitosan nanocrystals, starch nanocrystals or the like, or combinations or mixtures thereof. Illustrative inorganic nanomaterials may be or include, but are not limited to, one or more of silicon oxides (e.g., fumed silica), aluminum oxides, layered silicates or lime, or combinations or mixtures thereof. Illustrative layered silicates may be or include, but are not limited to, one or more of bentonite, kaolinite, dickite, nacrite, stapulgite, illite, halloysite, montmorillonite, hectorite, fluorohectorite, nontronite, beidellite, saponite, volkonskoite, magadiite, medmontite, kenyaite, sauconite, muscovite, vermiculite, mica, hydromica, phegite, brammalite, celadonite, or combinations or mixtures thereof.

The one or more additives may be present in an amount of from at least 0.1 weight %, based on a total weight of the hydrogel. For example, the one or more additive may be present in an amount of at least 0.1 weight %, at least 0.5 weight %, or at least 1 weight %, based on a total weight of the hydrogel. The one or more additives may also be present in an amount of 40 weight % or less, based on a total weight of the hydrogel. For example, the one or more additives may be present in an amount of 40 weight % or less, 20 weight % or less, or 10 weight % or less, based on a total weight of the hydrogel.

In at least one embodiment, the electrolyte composition may include an aqueous solvent. For example, the electrolyte composition may include water. In at least one embodiment, the electrolyte composition may include a co-solvent. For example, the electrolyte composition may include water and an additional solvent. Illustrative co-solvents may be or include, but are not limited to, one or more of ethylene glycol, propylene glycol, diethylene glycol, dipropylene glycol, or combinations thereof. The cosolvent may include water in an amount greater than about 20%, greater than about 30%, greater than about 40%, greater than about 50% to greater than about 60%, greater than about 70%, greater than about 80%, greater than about 85%, or greater than about 90%, by total weight or volume of the aqueous solvent of the electrolyte composition.

In at least one embodiment, the electrolyte composition includes the hydrogel of the copolymer and the salt dispersed in the hydrogel, a solvent (e.g., water or water and a co-solvent), one or more photoinitiators, the optional one or more additives, or combinations thereof. For example, the electrolyte composition includes the hydrogel of the copolymer, the salt dispersed in the hydrogel, the solvent, the one or more additives, or combinations or mixtures thereof. In at least one embodiment, the electrolyte composition consists of or consists essentially of the hydrogel of the copolymer, the salt dispersed in the hydrogel, and the solvent (e.g., water or water and a cosolvent). In another embodiment, the electrolyte composition consists of or consists essentially of the hydrogel of the copolymer, the salt dispersed in the hydrogel, the solvent, and the one or more additives. The solvent, which may be water or a combination of water and a cosolvent, may provide the balance of the hydrogel.

### EXAMPLES

Materials Used: GPE-3 Polymer EXP-21-AC2217 (solid gel polymer); GPE-3 Pre-cured solution EXP-21-AC1653-11 (high viscosity); Silver Flake—Inframat Advance Materials—47MR-10F; DELO DUALBOND Adhesive-Comparative Example (PE Conductive Adhesive); CI-2042 Carbon Conductive Paste; 100 micron thick PET sheets; PC boards

### Adhesive Formulations:

Example 1A: In an 80 mL jar, 7.38 grams of GPE-3 Polymer AC2217 (solid white gel at 27.28% solids) was added to 20 g of DI water and allowed to dissolve overnight. The final solution has 7.4% solids. The viscosity as observed was relatively low, similar to water.

Example 1B-1F: In a 3 dram vial, Silver Flake was added to 1 gram of Example 1A according to Table 2. It should be noted that ‘wt % silver flake in dry adhesive’ is the calculated wt % silver flake in the dry adhesive free of solvent (water) after curing. The mixture was then placed on a Fisher Scientific Digital Vortex Mixer at 3000 rpm for 1 minute.

TABLE 2
Silver Flake loadings in both wet adhesive formulations and
the corresponding dry cured adhesive for samples 1A-1F.

| | wt % Silver Flake in wet | wt % Silver Flake in dry |
|---|---|---|
| Example | adhesive | adhesive |
| 1A | 0 | 0 |
| 1B | 5 | 42 |
| 1C | 10 | 60 |
| 1D | 20 | 77 |
| 1E | 40 | 90 |
| 1F | 60 | 95 |

Observations (samples 1A-1F): Sample 1A exhibited a fairly low viscosity similar to water. Samples 1B-1D exhibit low viscosity with particles settling to the bottom over time. Particle settling time is shorter with lower loading of silver flake (1B>1C>1D). Samples 1E and 1F show no visible settling over time (8 hrs) and have higher viscosity, which appeared paste like.

Example 2A: The same procedure was used as in sample 1A except the GPE-3 gel (AC2250) was previously made into a pre-cured solution (AC1653-11) by dissolving GPE-3 into water to form a 25% solids loading solution that weighed 58.7 g. The viscosity was relatively high with little flow.

Examples 2B-2F: In a 3 dram vial, silver flake was added to 1 gram of Example 2A according to Table 3. Note that ‘wt % silver flake in dry adhesive’ is the calculated wt % silver flake in the dry adhesive free of solvent (water) after curing. The mixture was then placed on a Fisher Scientific Digital Vortex Mixer at 3000 rpm for 1 minute.

TABLE 3
Silver Flake loadings in both wet adhesive formulations and
the corresponding dry cured adhesive for samples 2A-2F.

| | wt % Silver Flake in wet | wt % Silver Flake in dry |
|---|---|---|
| Example | adhesive | adhesive |
| 2A | 0 | 0 |
| 2B | 10 | 31 |
| 2C | 20 | 50 |
| 2D | 40 | 73 |
| 2E | 60 | 85 |
| 2F | 80 | 91 |

Observations (samples 2A-2F): Sample 2A has a relatively high viscosity with slow flow. Samples 2B-2F all show no visible settling of particles over time and have a paste-like consistency.

Testing for Adhesion & Conductivity: A surrogate test for both adhesion and conductivity was performed by using the adhesive to bond a resistor to a PC board across a gap between silver printed lines. The gap is spanned by a surface mount 100 Ω resistor (603 package). The conductive adhesive is evaluated by measuring the resistance across the two silver lines. The adhesive is deemed sufficiently conductive if the measured resistance does not significantly add resistance above 100 Q. Table 4 shows the results for samples 1A-1F. Surrogate adhesion and conductivity test were performed using a 100 Ω resistor bonded across silver lines on a PCA board. Digital Multimeter (DMM) measurements above 100 Ω are contributed by the adhesive. Adhesion is qualitatively assessed by applying forces to remove the resistor. Adhesion of the resistor was evaluated qualitatively by the following method:
Level 0-turn the polycarbonate plaque over (no adhesion if resistor falls off)
Level 1-tap the back of the plaque with three fingers
Level 2-turn the plaque on its side and tap the plaque on a table
Level 3-apply light rubbing force using finger to pop off the resistor
Level 4-apply heavy push force using finger to pop off the resistor

TABLE 4
Measurement of added resistance (surrogate conductivity)
across a 100 Ohm resistor via adhesive interconnects
on PCA board printed with silver lines/pads. Adhesion
is the qualitative force required to remove the resistor.

| | wt % Silver Flake in wet | wt % Silver Flake in dry |
|---|---|---|
| Example | adhesive | adhesive |
| DELO IC343 | 1.2 | Level 4 |
| 1A | No Continuity | Level 4 |
| 1B | 0.7 | Level 4 |
| 1C | 1.6 | Level 4 |
| 1D | 2.7 | Level 4 |
| 1E | 2.9 | Level 4 |
| 1F | 2.6 (10.8)* | Level 3 |

Samples 1A-1F demonstrate that the addition of conductive silver flake particles produce useful conductivity and adhesion in the range of commercially available conductive adhesives. Particularly the adhesion to the PCA board looked to be as strong or stronger than the commercial adhesive. However, samples containing higher loadings of silver flake (1E-F) produce cracks and brittle connections that reduced both the adhesion and conductivity. Interestingly, the conductivity seems to go down with increasing silver flake content. This may be due to the fact that in sample 1B the silver flake particles were observed to have settled to the bottom of the layer after application. When applied as a film to a substrate, the settling of the flakes in the layer effectively leads to formation of a conductivity gradient with high conductivity at the bottom of the film, and no continuity at the surface.

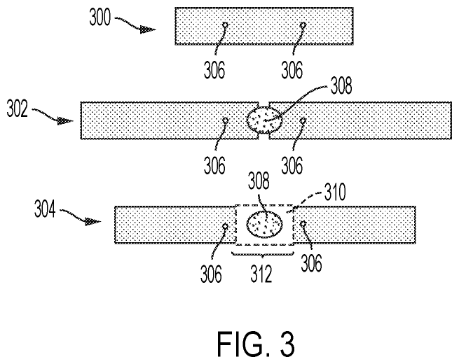

FIG. 3 is a schematic of an evaluation configuration for an electrochemical device connected using a conductive adhesive, in accordance with the present disclosure.

Carbon to Carbon Adhesion and Conductivity Test: CI-2042 conductive carbon ink was screen printed onto 100 micron thick 4 cm×4 cm PET films using a 180 mesh screen and an 80 durometer squeegee to emulate battery current collector tabs as used in batteries of the present disclosure. The films were heated to 140° C. for 10 minutes in a forced air oven giving a thickness of 6 μm dry film. The films were cut into 3 cm×0.8 cm strips and paired up for testing. An uncut strip was used as a control. 1 drop of conductive ink was placed in orientations of 3 cm strips of conductive carbon-coated PET for testing as depicted in FIG. 3. A control configuration 300 is shown, along with a bridged conductivity configuration 302 and a sandwiched configuration 304. The control configuration 300 is simply a single section of conductive carbon-coated PET. The bridged conductivity configuration 302 includes two sections of conductive carbon-coated PET bridged or connected by a portion or drop of conductive adhesive 308. The sandwiched configuration 304 includes two sections of conductive carbon-coated PET overlapped with an overlap segment 310 of conductive carbon-coated PET which forms an overlap 312 with carbon side facing down towards the adhesive. In each configuration 300, 302, 304, there are two probe location points 306 indicated, where DMM probes are positioned approximately 1 cm apart from one another. Once applied, the adhesive was allowed to air dry for 24 hours. The results are shown in Table 5. The pull adhesion strength was so strong for samples 1A-1D (and the heated DELO) that they required excessive manual force to break apart, and in all cases the carbon layer delaminated from the PET substrate.

TABLE 5
Conductivity and Adhesion results for bridge and sandwich
testing of samples 1A-1F using PET printed with CI-
2042 carbon paste to mimic battery tabs.

| | Control | Bridged | Sandwiched | Pull | Peel |
|---|---|---|---|---|---|
| Example | (Ohm) | (Ohm) | (Ohm) | Adhesion | Adhesion |
| DELO | 85.6 | No | No | None | None |
| IC343 | | Continuity | Continuity | | |
| DELO | 79.5 | 81.3 | 76.7 | Strong | Moderate |
| 1C343* | | | | | |
| 1A | 86.5 | No | No | Strong | Moderate |
| | | Continuity | Continuity | | |
| 1B | 78.5 | 82.9 | 84.7 | Strong | Moderate |
| 1C | 91.2 | 86.7 | 78.5 | Strong | Weak |
| 1D | 83.1 | 88.1 | 79.9 | Strong | Weak |
| 1E | 87.6 | 78.6 | 69.6 | Moderate | Weak |
| 1F | 84.9 | 79 | 85.4 | Weak | Weak |

*Commercially available DELIOEC343 at 100° C. for 20 minutes.

Alternative conductive particles that can be used in conductive paste formulations can include silver nanoparticles, carbon black, carbon nanotubes, combinations thereof, as well as other conductive additives known to those skilled in the art.

The present teachings provide a biodegradable PVA grafted PCL polymer based aqueous conductive adhesive that is curable at room temperature, alternatively by evaporation, high conductivity biodegradable adhesives with excellent adhesion to typically difficult to adhere to plastics. The adhesive possesses a high strength bond with carbon tab connections of batteries in series. These conductive adhesives and corresponding batteries and/or devices are easy to manufacture through addition of conductive particles to an aqueous solution of polymer in water. These conductive adhesives are useful as a tab interconnect adhesive for biodegradable batteries in series, as well as a general conductive adhesive for electronics and printed electronic interconnects on typically hard to adhere to materials and substrates.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

1. An electrochemical device, comprising:
a first electrochemical cell;
a second electrochemical cell, connected in series to the first electrochemical cell; and
a biodegradable conductive adhesive comprising a conductive additive and a copolymer including at least two polycaprolactone chains attached to a polymeric center block, wherein the polymeric center block comprises polyvinyl alcohol, disposed between the first electrochemical cell and the second electrochemical cell.

2. The electrochemical device of claim 1, wherein:
the first electrochemical cell further comprises a first anode, a first cathode, and a first biodegradable electrolyte composition disposed between the first anode and the first cathode; and
the second electrochemical cell further comprises a second anode, a second cathode, and a second biodegradable electrolyte composition disposed between the second anode and the second cathode.

3. The electrochemical device of claim 2, wherein the biodegradable conductive adhesive forms a connection between the first cathode of the first electrochemical cell and the second anode of the second electrochemical cell.

4. The electrochemical device of claim 1, wherein the first electrochemical cell comprises a stacked geometry.

5. The electrochemical device of claim 1, wherein the second electrochemical cell comprises a stacked geometry.

6. The electrochemical device of claim 1, wherein the biodegradable conductive adhesive further comprises a hydrogel of the copolymer and a salt dispersed in the hydrogel of the copolymer.

7. The electrochemical device of claim 1, wherein the conductive additive comprises silver.

8. The electrochemical device of claim 1, wherein the conductive additive comprises a flake-shaped particle.

9. The electrochemical device of claim 1, wherein the conductive additive comprises carbon.

10. The electrochemical device of claim 1, wherein the conductive additive is present in the biodegradable conductive adhesive in an amount from about 25 wt % to about 95 wt % based on a total weight of the biodegradable conductive adhesive.

11. The electrochemical device of claim 1, further comprising a third electrochemical cell, connected in series to the second electrochemical cell.

12. A method of assembling a biodegradable electrochemical device, comprising:
adhering a first component of a biodegradable electrochemical cell to a second component of the biodegradable electrochemical cell using a biodegradable conductive adhesive; and
drying the biodegradable adhesive; and
wherein the biodegradable conductive adhesive comprises a copolymer having at least two polycaprolactone chains attached to a polymeric center block, wherein the polymeric center block comprises polyvinyl alcohol.

13. The method of claim 12, wherein the biodegradable conductive adhesive further comprises a conductive additive.

14. The method of claim 13, wherein the biodegradable conductive adhesive comprises before the drying a biodegradable hydrogel including the copolymer and water.

15. The method of claim 13, wherein the conductive additive further comprises silver.

16. A biodegradable conductive adhesive, comprising:
a hydrogel comprising a copolymer having at least two polycaprolactone chains attached to a polymeric center block, wherein the polymeric center block comprises polyvinyl alcohol; and
water; and
wherein the hydrogel is biodegradable.

17. The biodegradable conductive adhesive of claim 16, further comprising a conductive additive.

18. The biodegradable conductive adhesive of claim 17, wherein the conductive additive comprises silver.

19. The biodegradable conductive adhesive of claim 16, further comprising a salt.

20. A biodegradable adhesive, comprising:
a dried hydrogel comprising a copolymer including at least two polycaprolactone chains attached to a polymeric center block, wherein the polymeric center block comprises polyvinyl alcohol; and
wherein the hydrogel is biodegradable.
